(19) United States
(12) Patent Application Publication
(10) Pub. No.: US 2019/0292097 A1
(43) Pub. Date: Sep. 26, 2019

(54) Method For The Production of a Coating For The Inner Surface of a Receptacle, and Receptacle Obtained by a Method of Said Type

(71) Applicant: Glass Surface Technology, Paris (FR)

(72) Inventors: Christophe WAGNER, Bussiere-Poitevine (FR); Alexis MARSAL, Limoges (FR)

(73) Assignee: Glass Surface Technology, Paris (FR)

(21) Appl. No.: 16/302,779

(22) PCT Filed: May 24, 2017
(86) PCT No.: PCT/FR2017/051303

§ 371 Date: Nov. 19, 2018

(30) Foreign Application Priority Data
May 25, 2016 (FR) 1654704

(51) Int. Cl. C03C 17/00; B65D 23/02

(52) U.S. Cl. CPC C03C 17/004; C03C 17/30; B65D 23/02

(57) ABSTRACT

The invention relates to a method for producing a hybrid organo-mineral layer (12) for coating the inner surface (13) of a receptacle as well as to said receptacle for holding products that are biocompatible for humans and/or animals. According to the invention, a solution is formed that contains at least one solvent, water, at least one complexing molecular alkoxysilane precursor, at least one organo-functional molecular precursor and/or silicone, and a catalytic acid, the complexed solution, which is undergoing hydrolysis and condensation, is applied to at least one portion of the inner surface of the receptacle, the applied solution is dried at a specific temperature, and the receptacle is conveyed away and stored.

The present invention relates to a process for the manufacture of a neutral, hybrid and barrier layer for the at least partial coating of the internal face of a receptacle.

It also relates to a receptacle obtained with such a process.

Manufacture of a (chemically) neutral, hybrid (having a complex network structure with organic/carbon-based parts) and barrier (preventing the migration of molecules therethrough) layer for the coating of the internal face of a receptacle is understood to mean the manufacture of a covering solution which forms, after gelling and then solidification, a layer of protective material, and also the covering proper, that is to say the surface affixing of such a solution to the surface of an object formed of another material, in order to create, after gelling and curing, this protective layer in an integral and lasting fashion (that is to say, greater than several years) compatible with the results acceptable as regards high-quality biocompatibility. Such a coating then modifies the physical and/or chemical surface properties of this other material (when it comes into contact with a product).

The invention has a particularly important although not exclusive application in the field of the manufacture of glass or plastic bottles intended to receive and preserve processed foodstuffs, pharmaceutical products or cosmetic products.

The invention thus and in particular makes it possible to minimize container/content and/or environment/content interactions, this being the case more particularly for storage requiring the preservation of products in a neutral way for a fairly long time (for example several months, indeed even years).

Conventionally, preservation in a neutral way is understood to mean preservation by a glass or a plastic exhibiting a release of ions over time, for example of sodium ions or other alkali metal and/or alkaline earth metal ions for glass, but also all other types of ions, such as those of antimony, phthalates, styrene or bisphenols, in particular for plastics, in very small amount into the liquid or product which is inside the receptacle.

Very small amount is understood to mean a ratio of total weight of the extractable elements to weight of the liquid contained of less than 6 ppm.

Soda-lime glass is not, for example, neutral within the meaning of the Pharmacopeia.

It is thus known that, when a glass bottle is manufactured, it is necessarily brought to high temperatures which result in particular in a migration of the alkali metals (in the case of a silicate glass), which rise to the surface of the glass and/or to its immediate proximity, in a way sufficient to be subsequently exposed to the content of the receptacle.

Likewise, plastic containers, in particular when they are heated, for example in a microwave oven, release substances toxic in themselves and/or by their interaction with the content of the receptacle.

In point of fact, the amounts of these substances, of alkali metal or of others, although generally very small, are a nuisance in the case of bottles intended to contain vaccines or cosmetic products, the active principles of which have to remain pure, or in the food sector, the contents of which are directly ingested by the user.

This is because the alkalinity or these other substances may cause dangerous effects with regard to a pharmaceutical product and/or cosmetic product or foodstuff, as a result of unacceptable reactions which might take place between the wall of the glass and the product.

A process is known (WO 2010/112792) for covering at least a fraction of an internal face of a receptacle with a vitreous material prepared according to the process known to a person skilled in the art under the generic term of sol-gel (diminutive of solution-gel).

The vitreous material, which is based on silica, is obtained without melting, by polymerization of at least one molecular precursor.

It comprises a synthesis stage carried out starting from alkoxides of formula M(OR)ₙ, where M is a metal or silicon and R is a CₙH₂ₙ₊₁ alkyl group dissolved in a conventional solvent, followed by a more or less lengthy stage of gelling with evaporation of the solvent until solidification is completed.

There is also known (FR 2 443 484) a process for preventing the filtration of a contaminant by a surface of a solid by formation of a thin film of silicon oxide coating starting from a heated hydroxysilane compound.

There is also known (EP 2 199 264) processes by formation of a surface vitrified silicon layer at a high temperature.

However, such processes do not make it possible to carry out a coating under cold conditions (ambient temperature) after final manufacture starting from shaped bottles.

There is also known (FR 2 886 309) a sol-gel formulation for coating a metal surface comprising organometallic elements (in particular Zi; Al; Ti) and aggressive and/or polluting acids, such as hydrochloric acid.

Such sol-gel processes comprise the introduction of numerous elements which are often undesired, in some instances dangerous and contrary to use in the cosmetic and/or pharmacological field.

They are in addition particularly complex and problematic to carry out and they concern specific applications/uses which cannot be readily extrapolated to other situations.

They thus do not make it possible, in a repetitive, simple and adjustable manner, to satisfactorily coat an interior surface with a sol-gel barrier layer having sufficient adhesion, this being the case independently of the shape of the receptacle.

They often require the introduction of additional elements and/or elements exhibiting a large amount of residues.

This is because the formulation of the solution has to make it possible to obtain a viscosity which makes possible the ready application of the solution while making possible gelling kinetics which limit the effects of the smears during the application, while making possible good stability over time, not leaving cracks in the applied layer after baking.

There is also known (FR 2 935 594) a process for coating with a sol-gel layer using dyes attached to the surface of the layer by covalent bonding.

Such a process, like the others, exhibits several disadvantages.

First of all, these processes use strong acids, such as hydrochloric acid (HCl), favored for the preparation of reactive solutions and the increase in the kinetics of the reaction.

In point of fact, such acids allow the passage of a residual amount of acid which in the long run disturbs the quality of the product contained.

Neither do they optimally provide a sufficient barrier with respect to the wall of the receptacle for its releases into the product contained.

These processes do not make it possible to truly increase the hydrolytic resistance, it being possible for the gain obtained, be that as it may, to be further improved, it being known that, even modest, such a gain with respect to the prior art is a significant advance in health terms.

In point of fact, the invention further makes possible an improvement in the matter, it being observed that the quality of the layers of the prior art and the effectiveness of their function of barrier to releases and to exudation phenomena deteriorate over time with excessively rapid kinetics for the constraints of duration of preservation, in particular for applications in pharmaceuticals or in cosmetics.

These processes are also specifically suited to one type of constituent material of the receptacle. They are, for example, particularly inappropriate and ineffective for specific vitreous materials and plastic in particular.

For these in particular, the amplitude of the mechanical deformations of the receptacle, for example during manual grasping or pressure for expelling a gelled content, require an increased mechanical strength and an increased hold of the layer which is poorly observed by the processes of the prior art.

This is particularly problematic when it is desired to functionalize this layer, that is to say to add to it chemical elements which make possible the expression of a specific function, such as: the coloring of the layer, the resistance to electromagnetic radiation, the addition of medical functions, in particular antibacterial functions, specific visual effects, or any other function.

These elements are then either released or do not completely provide their function and damage the hold of the layer to the detriment of its barrier capacity.

The present invention is targeted at providing a process, and a receptacle obtained in particular by such a process, responding better than those previously known to practical requirements, in particular in that it makes it possible to treat all the types of bottles, including of different substance, such as glass or plastic, this being done with the same formulation, independently of the suppliers of these and while generating less breakage or damage of the receptacles than in the prior art, in that it significantly improves the hydrolytic resistances (up to 50% improvement with respect to the processes of the prior art), mechanical strengths, thermal resistances and chemical resistances of the layer, in that it optimizes the attachment of the layer to the internal wall of the receptacle, in that it makes it possible to functionalize the layer without this being to the detriment of the hydrolytic strength and in that it makes it possible to operate in a confined environment with application by a sprayer.

The invention also makes it possible to obtain layers which are set or multilayers with a greater thickness and good reaction kinetics at the industrial level for lower treatment temperatures than in the prior art.

It is thus in particular an object of the present invention to employ these principles with the abovementioned advantages while overcoming the disadvantages of the prior art.

With this aim, it provides in particular a process for the manufacture of a neutral hybrid organo-inorganic barrier layer for coating the internal face of a receptacle suitable for containing products biocompatible with man and/or animals, in which:
a solution containing at least one solvent, water, at least one first complexing molecular precursor of the family of the alkoxysilanes, at least one second organofunctional molecular precursor and/or silicone, and citric acid as catalyst is formed,
the solution thus complexed is applied to at least a part of the internal face of the receptacle, the solution being in the course of hydrolysis and condensation, and
the solution thus applied is dried at a predetermined temperature before evacuation of the receptacle and storage.

By virtue of this process, the barrier thus formed is neutral and impermeable to radiation and to chemical entities in both directions of passing through the coating.

The coating is also more resistant.

Hybrid organo-inorganic layer is understood to mean a layer employing the precursors and/or silicone as specified above.

It should be noted that an alkoxysilane can have organic groups not directly attached to the Si atom, for example via oxygen ions.

An organo-inorganic precursor means, for its part, that there is at least one C atom directly attached to the inorganic ion.

These carbon-based chains make it possible to give functions to the coating, without being hydrolyzed, like the parts connected by oxygen ions.

Advantageously, the invention will in particular and for example employ organosilane precursors (which come within the family of the organo-inorganic precursors) in order to introduce reinforcing and/or attachment functions.

In this instance, octadecyltrimethoxysilane is the longest carbon-based chain (16 C), while dipodal silanes for their part exhibit two silane-based branches (making possible better attachment).

These precursors also introduce functions at the surface of the layer with the PFAS and the fluorines on the carbon-based chain.

Finally, use is also advantageously made of aluminum precursors and 3-(trimethoxysilyl)propyl methacrylate for strengthening the resistance of the layer and the mechanical reinforcement respectively.

With the invention, it is possible to carry out a colored internal marking by a protective layer of high hydrolytic resistance, including on plastic, and with, on the one hand, enhanced esthetic quality (absence of grain, homogeneity of the smear-free layer, even for high thicknesses) and, on the other hand, an optimized hold over time.

Despite the constant process of gelling/solidification, it is also possible to preserve, over the long term, the gel (partially gelled solution) produced from the above solution and to operate at ambient temperature.

In the course of hydrolysis and condensation is understood to mean the fact that the overall chemical reaction has not yet reached its final or maximum degree of progression.

It is known that the degree of progression ξᵣ of a reaction is defined by

$${ξ}_{r} = \frac{ξ}{ξmax}$$

with ξᵣ ε [0;1] and
ξ: degree of progression at the given instant t
ξₘₐₓ: final or maximum degree of progression.

Furthermore, the progression of the reaction is defined by

$$d ξ = \frac{dni}{vi}$$

with
dnᵢ: variation in the number of moles from the initial instant and
vi: stoichiometric number of the reaction.

In the case in point, the degree of progression has to be at a value of less than 1, making possible the microspraying.

Alternatively, in the course of hydrolysis and condensation is also understood to mean that the solution in the course of gelling has, at the instant t, a viscosity which makes possible a homogeneous application, for example a dynamic viscosity at 20° C. of between 1 and 150, for example between 3 and 80, and in particular of less than 50 mPa·s, for example of less than 20 mPa·s, for example of less than 10 mPa·s.

The progression of the reaction and the viscosity are in this instance related.

The density of the layer and also the possibility for the latter of being formed of a single closed surface (2 dimensions) devoid of holes, i.e. of 0 genus in topology, further increases the resistance to release of the internal surface of the bottle.

Solvent is understood to mean a substance other than water which has the property of dissolving, diluting or extracting other substances without chemically modifying them and without itself being modified.

Manufacture of a barrier layer for coating the internal face of a receptacle is understood to mean the manufacture of a covering solution which forms, after gelling and then solidification, a layer of protective material, and also the covering proper, that is to say the surface affixing of such a solution to the surface of an object formed of another material, in order to create, after gelling and curing, this protective layer in an integral and lasting way (that is to say, greater than several years).

More specifically, a better barrier effect is observed when the hydrolytic resistance during successive measurements is on average better than with the prior art by at least ten percent, advantageously 30%, indeed even 50% and up to 80% (and thus the capacity for release, which is proportional to it).

Neutral layer for covering a wall of a receptacle is understood to mean a layer which does not release, into the liquid contained in said receptacle, elements in an amount of greater than a few ppm, for example 1 or 2 ppm, after being brought into contact for a predetermined time with the liquid at a test temperature, for example 45° C. for one month.

Finally, the final stage of drying at a predetermined temperature advantageously takes place immediately after the application of the solution.

Immediately is understood to mean straightaway or within the few minutes which follow as a function of the industrial process (<60 min).

It is this drying stage which definitively forms the hard barrier layer according to the embodiment of the invention more particularly described here and which will be used as is, after optional storage, to be filled by the perfumer.

No other process stage, such as heating or chemical treatment, is thus provided after this drying stage before the filling.

The release of ions by the receptacle is greatly reduced.

In other words, the ability of a receptacle, the internal face of which is substantially entirely covered, to withstand the release of elements is improved.

To sum up, the hybrid organo-inorganic coating material of the present invention thus makes it possible to provide a barrier function not only for the product contained with regard to external influences but also releases inside the product by the walls of the receptacle or by the layer itself, and also to limit the interactions between the coating and the walls of the receptacle.

Such a result is obtained without subsequent treatment of the receptacle (whether a heat or chemical treatment) and under appropriate storage conditions, the measurements being carried out, for example, via the determination methods provided by the standard ISO 4802-2 or by titration according to the standard ISO 4802-1.

Conventionally, the hydrolytic resistance is measured before treatment and after treatment by determination of the amount of sodium oxide and of other alkali metal or alkaline earth metal oxides released during a treatment in an autoclave at 121° C. for 60 minutes, the measurements being, for example, subsequently carried out in a way known per se by flame spectrometry.

In the present patent application, reference will be made without distinction to the hydrolytic resistance and to the ability of the layer to withstand release from a glass or plastic wall, the measurements of this being carried out by any process known per se to the person skilled in the art, such as, for example, by flame spectrometry.

With the invention, it is thus found that subsequent releases, in particular as tested in standardized fashion in an autoclave or other as described above, no longer make it possible to measure significant degrees of release.

Advantageously and in the case of glass receptacle or bottle, a preheating of the bottles at 80-90° C. is carried out, which preheating makes it possible to promote the attachment of pharmaceutical industry hybrid layers, for example.

In advantageous embodiments, recourse is had, furthermore and/or in addition, to one and/or other of the following arrangements:
the solution comprises at least two first precursors and/or at least two second precursors;
the solution comprising at least one second precursor and silicone, it also comprises a surfactant;
in the case of glass receptacle or bottle, the predetermined drying temperature is between 140° C. and 220° C.;
the solvent comprises butoxyethanol and/or ethanol;
the first precursor is taken from tetraethyl orthosilicate and trimethoxymethylsilane;
the surfactant is taken from polyethylene glycols with a molar mass of between 1000 and 2000 g·mol⁻¹, and polyethylene glycol tert-octylphenyl ether (known under the name Triton™ X-100 from Thermo Fisher);
the silicone is polydimethylsiloxane with a viscosity of 10 centistokes at 25° C. or polyphenylmethylsiloxane with a viscosity of 20 mPa·s at 25° C.;
the catalyst acid is citric acid;
the second precursor is taken from the family of dipodal silanes. The use of dipodal silanes makes possible in particular very good attaching of the coating layer to the receptacle, in particular made of glass;
the second precursor is taken from octadecyltrimethoxysilane, 1,2-bis(triethoxysilyl)ethane, bis(3-(trimethoxysilyl)propyl)amine and the family of the fluoroalkylsilanes;
the solution comprises, for a total volume of 100 units, a mixture of between 58 and 77 units by volume of solvent, said volume of solvent comprising, for a total volume of solvent of 100 units, between 50 and 95 units by volume of butoxyethanol and between 5 and 50 units by volume of ethanol, between 8 and 28 units by volume of first precursor (alkoxysilanes), between 4 and 11 units by volume of second precursor (organosilanes), between 0.3 and 2 units by volume of acid and between 3 and 17 units by volume of water;
the solution comprises, for a total volume of 100 units, between 62 and 77 parts of solvent, including, for a total volume of solvent of 100 units or parts, 50 to 95 parts of butoxyethanol and from 5 to 50 parts of ethanol, between 6 and 20 parts of first alkoxysilanes precursor (for example TEOS), between 8 and 12 parts of organosilanes precursors, between 1 and 14 parts of silicone oil and between 0.3 and 1 part of citric acid and between 2 and 4 units by volume of water;
a pigment and/or functional additive is added to the solution, for example, but nonlimitingly, pigments known under the Iriodin™ or Pyrisma™ names, registered brand names of Merck. They are products sold as powder comprising mica, TiO₂ (rutile) (29-48% in Iriodin™ and 57-67% in Pyrisma™) and SnO₂ (1-25 microns);
a solution comprising surfactant is formed by:
a first stage of formation of a first mixture of surfactant and of solvent, and the first mixture is placed under stirring for a first predetermined time, with or without subjecting this first mixture to ultrasound,
a second stage of formation of a second mixture of solvent and of first and second precursors, and the second mixture is placed under stirring for a second predetermined time,
a third stage of dropwise introduction of the acid into the second mixture in order to form a third mixture, and the third mixture is placed under stirring for a third predetermined time,
and then by mixing the first mixture and the third with stirring for a fourth predetermined time.

The first, second and third predetermined times are between 1 min and 30 min, and are optimized as a function of the respective amounts of the mixed products in order to make possible an optimized complexification. The fourth time with all the ingredients lasts at least 240 min.

The invention also provides a receptacle obtained by the process described above.

It also relates to a receptacle suitable for containing products biocompatible with man and/or animals, comprising an internal surface, characterized in that said internal surface is covered, over at least a part, with a solidified sol-gel coating layer obtained from a solution containing at least one solvent, water, at least one first complexing molecular precursor of the family of the alkoxysilanes, at least one second organofunctional molecular precursor and/or silicone, and a catalyst acid, said coating forming a hybrid organo-inorganic matrix arranged in order to produce at least one chemical barrier.

Advantageously, the coating layer has a thickness of between 60 and 450 nm (when it does not contain pigment of micrometric size).

Also advantageously, the solution comprises SiO₂, a colored pigment taken, alone or in combination, from metal oxides comprising cobalt and titanium, metal oxides comprising copper and chromium, photochromic pigments, families of compounds comprising micas (such as Pyrisma™ and/or Iriodin™), quinacridone, phthalocyanine, quinophthalone and compounds formed of a layer of aluminum and/or its oxides, compounds comprising colloidal nanosilver particles and/or titanium oxides and/or cerium oxides and/or silver or carbon black.

Particularly advantageously, the pigment comprises micas.

In an advantageous embodiment, the receptacle is made of glass.

Also advantageously, the receptacle is made of plastic or of aluminum.

A better understanding of the invention will be obtained on reading the description which follows of embodiments described below as nonlimiting examples and with reference to the figures which accompany it, in which:

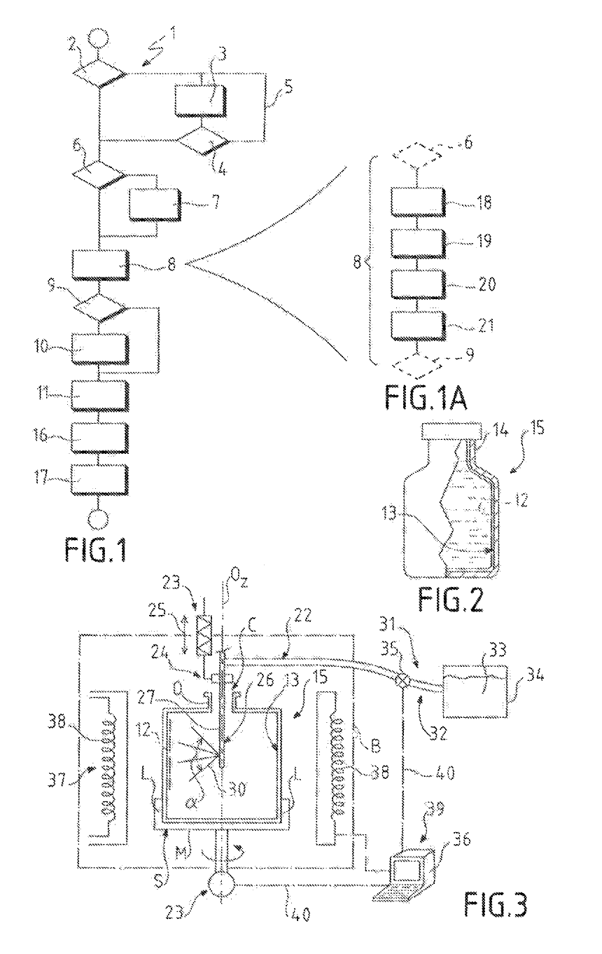

FIG. 1 is a flow chart showing the stages of a process for the manufacture of a coating layer according to one embodiment of the invention.

FIG. 2 is an embodiment of a receptacle according to the invention.

FIG. 3 diagrammatically shows, in section, an embodiment of a device implementing the process according to one embodiment of the invention.

FIG. 1 shows a flow chart 1 giving the main stages of a process according to the embodiment of the invention more particularly described here.

The process comprises a preliminary stage (not represented) of supplying with at least one receptacle or bottle to be treated.

The receptacle is formed of a material which, suitably treated, will make it possible to contain products biocompatible with man and/or animals, that is to say compatible with an ingestion and/or an application to the human or animal body (medicaments, cosmetic products, and the like).

More specifically, the process comprises first of all or not (test 2) a stage 3 of passivation of the internal face of the receptacle in a way known per se. This is, for example, by filling with an aqueous extraction liquid, for example made of water of R or R₁ grade, then emptying the water after a predetermined time.

Each of the passivation embodiments (stage 3) can be repeated several times (test 4-5), for example twice.

This passivation stage further reduces the amount of ions which risk being released subsequently into the content of the receptacle, in particular when the coating layer does not cover all or most of the internal surface of the receptacle.

It also advantageously prepares the internal face for the adhesion of the coating layer.

The (optional) passivation stage is subsequently and for example (test 6) followed by a stage 7 of preparation of the support.

This stage can, for example, be a stage of preheating between 80° C. and 90° C. (for glass or plastic bottles).

After this stage, a stage 8 of preparation and of formation of a solution according to the invention is carried out, if this has not been carried out beforehand in parallel or otherwise, for example in a separate place and in a period of time before its application which can reach several hours.

The preparation stage 8 comprises a stage of mixing the constituents of the layer.

In a first embodiment, the mixing is carried out, for example, in a vat with stirrer at a predetermined temperature and for a predetermined time, for example at a temperature of between 10° C. and 50° C., for example of between 15° C. and 35° C., for example 24° C. (ambient temperature), and mixed for a period of time of, for example, between 10 min and 1 h, for example between 25 min and 45 min, for example 30 min.

The constituents of the mixture are added substantially simultaneously, the constituents thus being formed of at least one solvent, water, of at least one first complexing molecular precursor of the family of the alkoxysilanes, of at least one second organofunctional molecular precursor and/or of silicone and of a catalyst acid, this being done in proportions which are arranged in order to form, in the end, a solution which is the source of a hybrid organo-inorganic barrier suitable for producing at least one chemical barrier, and which will be described in detail below.

The mixing stage 8 is followed by (and/or comprises), if the need arises (test 9), an addition (stage 10) of at least one surfactant and/or of at least one pigment.

There follows a stage 11 of application of the complex solution 12 thus formed (see FIG. 2) to a part of the internal face 13 of the wall 14 of the receptacle 15 to be coated, said solution being in the course of hydrolysis and of condensation. Then a stage 16 of drying the solution, applied at a predetermined temperature depending on the material of the receptacle, is carried out, before a stage 17 of evacuation and storage.

In one embodiment (FIG. 1A), and for example in the case where the process employs a surfactant, the mixing stage 8 comprises a first substage 18 of formation of a first mixture of surfactant and of solvent (for example 0.5 g of surfactant dissolved in 7 to 10 ml of solvents) g of the final mixture) for a first predetermined time, for example of a few minutes, with alternating treatments with ultrasound.

It is also possible here to add the silicone, after dissolution of the surfactant.

A second substage 19 of formation of a second mixture of solvent and of first and second precursor is then carried out, which mixture is placed under stirring for a second predetermined time of greater than 5 min, preferably of greater than 15 min, for example 20 min, when a highly reactive dipodal amine is concerned.

This will make it possible to have between 8 and 28 parts of alkoxysilane precursor and between 4 and 25 parts of organosilane sources.

A third substage 20 of dropwise introduction of the acid, for example citric acid, into the second mixture is subsequently carried out, in order to form a third mixture with mixing for a third predetermined time of greater than 10 min, for example 15 min.

The first mixture is then mixed (stage 21) with a third mixture for a fourth predetermined time of between 3 and 6 h, for example 4 h.

The mixing proportions and times, and also the rates at which they are carried out, are adjusted according to the characteristics desired for the coating, and in a tailored way within the scope of the person skilled in the art, in order to obtain the hybrid matrix of the desired thickness and the role of the desired chemical barrier for several months and in the light of the extrapolatable results described in detail below with reference to tables I to III.

As indicated above, the mixing operations are carried out in aqueous liquid which makes possible the hydrolysis of the precursors, and good fluidization making possible easier application.

The citric acid solution, before introduction into the mixture, has, for example, a concentration of 1.04 mol/l (of between 0.5 and 1.6 mol/l). In the sol prepared, the acid concentration is from 0.05 to 0.3 mol/l.

The catalysis and the drying, for example at 70° C. for the plastic material and between 140° C. and 220° C. for the glass, for example 180° C., result in a gelling being obtained which gives a solid layer, even without additional curing.

In the embodiments more particularly described here, the solvent is butoxyethanol or ethanol, the first precursor is tetraethyl orthosilicate (TEOS), the second precursor is octadecyltrimethoxysilane and/or dipodal amine, the citric acid has a concentration of between 3 and 19 parts of aqueous acid solution per 100 parts by value of the total solution, and the silicone, polydimethylsiloxane, has a viscosity of 10 centistokes at 25° C.

The parameters of the different tests 1 to 20 carried out have been represented in table I below, making it possible to illustrate the excellent results of the invention, in comparison with a crude bottle (test 1—reference glass) and a bottle covered with a conventional (nonhybrid) sol-gel layer (test 2) as produced according to the process described below, with butoxyethanol as solvent, just one precursor (TEOS), acid (in this instance citric acid, able to make possible the comparison, although such an acid is not used in a known way as it is not very active in a sol-gel reaction) and polyethylene glycol (PEG) with a molecular weight of 1500 g·mol⁻¹ (as additional solvent).

The following parameters were subsequently varied:
addition of ethanol as additional and/or complementary solvent (tests 3 to 20) in various proportions while furthermore varying the proportions of the first solvent, i.e. butoxyethanol;
addition of octadecyltrimethoxysilane as second precursor (tests 4 to 20);
the proportions of citric acid (tests 2 to 20);
the drying and its temperature (tests 2 to 20), the latter, however, being chosen, for most of the tests, at 200° C. for 1 hour, in order to make possible the comparison;
addition or nonaddition of a second precursor, in this case a dipodal amine (tests 16 to 20);
addition of silicone (tests 15, 17 to 20);
implementation of a prior drying operation (test 14).

The results of these different tests (cf. table III) are subsequently examined in the light of the following criteria:
Criterion A: indicating the hold in hours before degradation of the coating at 50° C. in the case of attack on the latter by concentrated citric acid buffered at pH 8 by addition of sodium hydroxide solution (3%, pH 8) (<65 means less than 65 hours)
Criterion B: the hydrolytic resistance (HR)
Criterion C: the mechanical deterioration (observed visually)
Criterion D: the τ of extractable element or in other words the total amounts of extractables in microgram/l (initials of Inductively Coupled Plasma)
Criterion E: comments.

The receptacle used is a round 100 ml flask made of type 3 glass (standardized).

The tests were carried out according to the following protocol:

Preparation:
0.1 g of PEG 1500 and the silicone, if the need arises, are dissolved in 2 ml of butoxyethanol (hereinafter also denoted by the abbreviation “buto” or “butoxy”) in a beaker with stirring for of the order of 45 min, the time in fact to dissolve the surfactant.
11 ml of butoxy and the TEOS are introduced into a flask, in order to obtain a second mixture which is left stirring for 20 min.

It is also at this stage that there will be introduced, for the tests concerned, the 2 ml (or 2.5 ml) of octadecyl, the dipodal amine, if the need arises, and/or the 400 μl of dipodal BTSE, and the like. The dipodal BTSE is an organofunctional precursor of formula 1,2-bis(triethoxysilyl)ethane.
After these 20 min of stirring the solution or sol, the amount of aqueous acid solution is introduced therein and mixing is carried out for 15 min.
The mixture of the buto+PEG 1500+the silicone, if the need arises, beaker is then introduced into the sol.
Everything is mixed for 4 h.

The following are provided for the application of the sol to the internal surface of the bottle:
The sloping or the nonsloping of the bottle with respect to the axis of the nozzle which is in this instance used for the spraying over the wall to be coated.
Its rotating.
The vibrating of the nozzle in order to facilitate the passage and the dispersion of the product.
The control of the flow rate of the product and of the air pressure which can vary during the deposition cycle, carried out in a way within the scope of a person skilled in the art, in order to optimize the application in the light of the other parameters.

In conclusion, table I gives the characteristics of the tests carried out. Table II gives the additional elements supplementing the characteristics specified in table I for tests 15 to 20 and table III gives the results of the tests for the proportions and mixtures as described in detail in tables I and II.

TABLE I

| | | | | Octa- | | PEG | |
|---|---|---|---|---|---|---|---|
| | Buto | Ethanol | TEOS | decyl | Acid | 1500 | Drying |
| Test | ml | ml | ml | ml | ml | g | ° C. |
| 1 | | | | | | | |
| 2 | 14 | | 4 | | 4000 | 0.1 | 200-1 h |
| 3 | 7 | 7 | 4 | | 4000 | 0.1 | 150 |
| 4 | 16 | 1 | 2 | 2 | 1000 | 0.1 | 200-1 h |
| 5 | 16.3 | 1 | 2 | 2 | 750 | 0.1 | 200-1 h |
| 6 | 11.5 | 6 | 2 | 2 | 600 | 0.1 | 200-1 h |
| 7 | 16.5 | 1 | 2 | 2 | 500 | 0.1 | 200-1 h |
| 8 | 10.5 | 7.4 | 2 | 2 | 100 | 0.1 | 200-1 h |
| 9 | 16 | 1 | 2 | 2 | 1000 (50% | 0.1 | 200-1 h |
| | | | | | acid) | | |
| 10 | 16.3 | 1 | | 2 | 750 | 0.1 | 200-1 h |
| 11 | 16.3 | 1 | 2 | 2 | 750 | 0.1 | 200-3 h |
| 12 | 16.3 | 1 | 1.5 | 2.5 | 750 | 0.1 | 200 |
| 13 | 16.5 | 1 | 2 | 2 | 500 | 0.1 | 200-1 h |
| 14 | 13.5 | 4 | 2 | 2 | 500 | 0.1 | 200-1 h |
| 15 | 16 | 1 | 2 | 2 | 750 | | 200-1 h |
| 16 | 16 | 1 | 2 | 2 | 750 | | 200-1 h |
| 17 | 16 | 1 | 2 | 2 | 750 | 0.1 | 200-1 h |
| 18 | 16 | 1 | 2 | 2 | 750 | 0.1 | 200-1 h |
| 19 | 13 | 1 | 2 | 2 | 750 | 0.1 | 200-1 h |
| 20 | 16 | 1 | 2 | 2 | 750 | 0.1 | 200-1 h |

TABLE II

| | | | | Pre- | |
|---|---|---|---|---|---|
| | Dipodal | | | heating | |
| | amine | Dipodal | Silicone | bottle | Drying |
| Test | microliters | BTSE | microliters | ° C. | ° C. |
| 14 | | | | 80 | 200-1 h |
| 15 | | | 400 | | 200-1 h |
| 16 | 200 | | | | 200-1 h |
| 17 | 200 | | 400 | | 200-1 h |
| 18 | 50 | | 400 | | 200-1 h |
| 19 | 125 | 400 | 3000 | | 200-1 h |
| 20 | 200 | | 400 | | 200-1 h |

TABLE III

| | Aging | HR | Resistance | Extractables | Comments |
|---|---|---|---|---|---|
| Test | A | B | C | D | E |
| 1 | | 3.04 | Poor | 16 | |
| 2 | | 0.7 | | 13.03 | HR improvement but |
| | | | | | extractables still |
| | | | | | high |
| 3 | | 0.41 | | 24.38 | Ditto |
| 4 | <65 | 0.08 | OK | 1.58 | Marked improvement |
| 5 | <130 | 0.07 | OK | 1.29 | More homogeneous |
| | | | | | and stable sol |
| 6 | | 0.36 | — | 2.38 | Clearer |
| | | | | | preparation |
| 7 | | 0.3 | — | 1.5 | Clearer |
| | | | | | preparation |
| 8 | | 0.45 | — | 2.93 | Clear preparation |
| 9 | <130 | 0.15 | — | 1.72 | Homogeneous white |
| | | | | | sol |
| 10 | <130 | 0.07 | OK | 1.29 | More homogeneous |
| | | | | | and stable sol |
| 11 | <65 | 0.21 | — | 1.29 | Excessively long |
| | | | | | baking |
| 12 | | 0.53 | — | 3.02 | Too much octadecyl |
| 13 | | 0.3 | — | 1.5 | Clearer sol |
| 14 | 200 | 0.39 | OK | 2.03 | Preheating makes |
| | | | | | possible a |
| | | | | | reinforcement of |
| | | | | | the hold |
| 15 | >480 | 0.45 | — | | Silicone makes |
| | | | | | possible a better |
| | | | | | chemical |
| | | | | | resistance but a |
| | | | | | poorer hold HR |
| 16 | <65 | 0.25 | OK | 2.78 | Coating grainy |
| | | | | | appearance |
| 17 | >415 | 0.37 | OK | 1.94 | |
| 18 | <200 | 0.22 | OK | | Not enough dipodal |
| | | | | | amine to withstand |
| | | | | | aging |
| 19 | >415 | 0.26 | OK | | Amount of dipodal |
| | | | | | amine optimized |
| | | | | | for resistance and |
| | | | | | appearance |
| 20 | >415 | 0.34 | OK | | Idem with even |
| | | | | | better appearance |

Table III shows that the glass alone (test 1) exhibits characteristics of poor resistivity HR and poor extractability (tested in a known way as specified above).

The glass treated with a conventional sol-gel (tests 2 and 3) exhibits a better resistivity (lower HR) but has, on the other hand, a very high degree of extractability.

Such results have in particular resulted in a rejection by the user of sol-gel coating techniques in the fields where the absence of contamination is highly desired, even if a drying at 200° C. (test 2) makes it possible to improve the results.

With tests 4 to 20, where a second precursor (octadecyltrimethoxysilane) in addition to the first precursor (TEOS) is provided and a first solvent (butoxyethanol) and a second solvent (in a ratio of 1.5 to 16), namely ethanol, excellent results are obtained as regards HR and extractability.

The mechanical strength is satisfactory overall.

However, it should be noted that, in tests 4 to 8, where the amount of first solvent is varied, better results are obtained by increasing the proportion, everything otherwise being equal, of butoxyethanol, and also by varying the amount of acid.

Test 14 shows the usefulness of a preheating, in comparison with the absence of preheating (test 13), on the hold.

Tests 15 and 17 to 20 show the sizable improvement which is brought about by the addition of silicone, in particular in combination with the addition of a second precursor (the dipodal amine), for a better hold with regard to aging with citric acid, tests 18 to 20 (compared with test 17) demonstrating, however, that a sufficient amount of second precursor (dipodal amine or dipodal silica) is necessary if it is desired to improve the resistance to aging.

In all these embodiments, the first molecular precursor is tetraethyl orthosilicate, known to a person skilled in the art under the abbreviated name TEOS, and the catalyst is citric acid.

Advantageously, the solvent and the first precursor are mixed, and then the second precursor and the citric acid, the amount of water for dissolution of the citric acid being sufficient and/or calculated in order for there to be no other contributions of water.

In one embodiment, additives appropriate for performing a function are added to the mixture.

The functions can be to block content-container and environment-content interactions, such as to limit the release, to color or add visual effects to the layer, to block radiation (for example UV radiation), to capture oxygen, to modify the surface activity or energy in order to influence the factors for sliding the product over the wall of the receptacle, to capture oxygen-containing compounds and/or oxygen, to render secure in biological terms (biocidal function, antibiotic function and the like).

These functions are produced by addition, to the sol-gel, in solution, of elements taken, for example, from the group SiO₂, colored pigment, cerium oxide and/or silver.

The amount added is correlated with the nature of the desired function. For example, a blocking function can be produced by addition of SiO₂ in a concentration, for example, of between 3.5 g·l⁻¹ and 20 g·l⁻¹, for example of between 4.5 g·l⁻¹ and 18 g·l⁻¹, and/or a biocidal function can be produced by an addition of silver in a concentration, for example, of between 0.9 g·l⁻¹ and 2.5 g·l⁻¹, for example of between 1.1 g·l⁻¹ and 2.2 g·l⁻¹.

After this stage, which is not obligatory, the process according to the embodiment of the invention more particularly described here comprises stage 11 of application of the solution in the course of gelling, for example to at least a part of the internal surface of the receptacle concerned, for example ¾, and/or for a predetermined design (letters, name of products, logos, and the like). The application thus forms a coating layer on said portion of the internal face.

The coating solution or gel is then evenly affixed to the internal surface of the receptacle, such as to obtain a deposited layer of a substantially identical even thickness at the chosen spot.

Stage 11 can be carried out in several ways and an embodiment of a device for application of the layer according to the invention will more particularly be described with reference to FIG. 3 in a way which is in no way limiting.

The application can be carried out immediately subsequent to the formation of the solution, after the start of the gelling or may be delayed.

With respect to an end of the stage of preparation of the solution at a moment t0, the application can start, for example, at a predetermined moment t0+h, h being a duration in hours.

As the gel is substantially the same temperature as that of the formation of the solution, the person skilled in the art will adjust the duration and the conditions of storage, transportation and/or preparation before application of the postponed substance in order to obtain the rheological conditions (viscosity, coupling rate, adhesion, and the like) which are optimum and/or desired for the application envisaged, by noting that the change in viscosity follows the change in the duration.

For example, at ambient temperature, h is less than 10 h, for example less than 6 hours, for example 3 h.

If the gel is preserved at a predetermined temperature lower than the formation temperature, as the kinetics of the change in its physicochemical characteristics is then reduced, it may be preserved for a subsequent application for several weeks.

For example, the duration of preservation before use may be a predetermined duration of less than 4 days, for example of less than 3 days, for example of less than 2 days, in the case of the use of citric acid.

The temperature is then, for example, less than 10° C.

After the application stage, there follows stage 16 of drying the gel thus applied at a predetermined temperature and for a predetermined time.

In one embodiment, the receptacles comprising an opening are placed in the vertical direction with the opening at the bottom, so as to evacuate the excess solution applied.

The receptacles are dried in an oven, for example a ventilated oven, at a predetermined temperature and for a predetermined time.

If the constituent material of the receptacle is glass, the temperature is, for example, between 140° C. and 220° C., for example 200° C., for a drying time of between 15 min and 3 h, for example between 30 min and 2 h, for example 1 h, at 200° C.

If the constituent material of the receptacle is plastic, the temperature is, for example, between 15° C. and 90° C., for example at 80° C. (for 1 hour), for a drying time of between 10 min and 120 min, for example 60 min.

The drying depends on the nature of the solvent, the drying time and temperature having to be adjusted to the latter. In particular, the temperature has to be greater than the boiling point of the solvent at a predetermined pressure.

In another embodiment, the drying is carried out for a duration and at a temperature which are mentioned above but the receptacles are placed in an oven of known type.

The successive stages of application of the solution forming coating product to a part of said internal face, of evacuation of the excess coating solution and of drying the product can be repeated a predetermined number n of times.

The number n is, for example, greater than or equal to two, for example greater than or equal to three, that is to say that the stages are repeated at least three times.

Once dried, the receptacle is brought back to an ambient temperature along a predetermined temperature curve.

The curve of rise in temperature of the receptacle can be linear or stepwise, and for example, follows an affine curve, for example, in order to dry the receptacle up to the maximum drying temperature selected, the director coefficient of the (heating) temperature curve being between 2° C./min and 5° C./min.

The fall in temperature is, on the other hand, left free in order to be slow and to consequently prevent cracks on the coating layer, to cause good adhesion and to limit the differential expansion stresses of the layer and of the wall of the receptacle.

Subsequently, the same reference numbers will be used to denote identical or similar elements.

FIG. 3 shows a device 22 for coating 12 at least a portion of the internal surface 13 of a receptacle 15, according to the embodiment of the invention more particularly described here.

The receptacle 15 is, for example, a cylindrical bottle made of glass extended around an axis O_{z}. It comprises, at one of its ends (top end), an opening as a bottleneck. The opening of the bottleneck comprises a neck C with a smaller diameter than that of the receptacle or bottle.

The receptacle thus substantially forms a chamber.

The device comprises a support S of the receptacle, for example comprising a retention clamp M in the shape of a dish or of a U, the branches L of which grip the base, that is to say the bottom, of the receptacle fixed via lateral screws (not represented).

Means 23 for rotating the receptacle around its axis O_{z} at a predetermined speed V are provided which are known per se. The speed V can be unchanging or variable and regulated. More specifically, the means comprise, for example, a rotating rod for driving the support which extends along the axis O_{z} and a motor for driving in a way known per se.

Means 24 for insertion/extraction (arrow 25) of a spraying tool or nozzle 26 inside the receptacle are mounted on a frame B, as dot-and-dash lines in the figure, on the side of the bottleneck of the receptacle 15.

The nozzle 26 comprises a longitudinal shaft or tube 27 connected, at its end, to the insertion means 24 comprising an actuator 28 for longitudinal displacement, such as a jack.

The action of the jack, which is integral with the nozzle 26, relocates the latter from an initial position external to the receptacle 13 to its positions (for example which can vary according to a predetermined coating program) of operation internal to the receptacle along the axis O_{z}.

It thus makes possible a gradual descent, continuous or stepwise, of the tool for application of the coating solution (gel in formation) to the internal surface of the receptacle.

A sequence of points or lines with times and speeds adjusted in order to match the shape of the bottle can be employed in addition to and/or as replacement for the rotational movements.

The nozzle brings about vaporization 30 along a predetermined solid angle α for dispersion which depends on the ejection rate and pressure controlled in a way known per se.

The tube is connected, at its opposite end, to a system 31 for dispensing a liquid coating solution according to the invention to be sprayed comprising means 32 for feeding the liquid or substantially liquid solution 33 in order to make possible the spraying, at a predetermined flow rate D.

The system 31 thus comprises a tank 34 for storage of said liquid and means 35 for moving the liquid (metering pump) arranged in order to regulate the flow rate D of the liquid via a calculator 36 and also controls the other actuators employed in the device.

The tank comprises, in its bottom, a mixing means, for example a stirrer (not represented).

The coating gel is thus the curable liquid hybrid coating material obtained by the process according to the invention and in particular according to the embodiment of the invention more particularly described above.

The device also comprises means 37 for heating the receptacle 13 known per se which make possible the rise in the temperature of a part of the internal surface of the receptacle up to a predetermined temperature threshold for drying.

More specifically, the heating of the internal surface is carried out, for example, by direct radiation from heating resistors 38 positioned outside the receptacle or by diffusion around the wall of the receptacle positioned in contact, for example, with a heating muffle (not represented).

In one embodiment, the receptacle and the resistor are substantially confined in one and the same chamber so as to form an oven for homogeneous heating of the receptacle.

The device also comprises a computer or automaton 39 for digital control comprising the calculator 36.

These are connected via a data bus 40 and in a way known per se to the actuators of the device, namely to those of the retention clamp of the receptacle, that is to say of the motor for driving in rotation, to those of the means 24 for insertion of the nozzle 26 into the receptacle (jack), the stirrer, and also to those of the means 35 for moving/feeding with liquid (pump, valve, nozzle) and heating means 37 (electrical resistors).

The calculator 36 is arranged in order to calculate, from the different set points imposed, a law for controlling each of the actuators in a way known per se.

As is obvious and as also results from the above, the present invention is not limited to the embodiments more particularly described. On the contrary, it encompasses all the alternative forms thereof and in particular those where the device implementing the process is different.

1. A process for the manufacture of a neutral hybrid organo-inorganic barrier layer (12) for coating the internal face (13) of a receptacle (15) suitable for containing products biocompatible with man and/or animals, in which:
a solution containing at least one solvent, water, at least one first complexing molecular precursor of the family of the alkoxysilanes, at least one second organofunctional molecular precursor and/or silicone, and citric acid as catalyst is formed,
the solution thus complexed is applied to at least a part of the internal face (12) of the receptacle, the solution being in the course of hydrolysis and condensation, and
the solution thus applied is dried at a predetermined temperature before evacuation of the receptacle and storage.

2. The process as claimed in claim 1, characterized in that the solution comprises at least two first precursors and/or at least two second precursors.

3. The process as claimed in claim 1, characterized in that the solution comprising at least one second precursor and silicone, it also comprises a surfactant.

4. The process as claimed in claim 1, characterized in that the predetermined drying temperature is between 140° C. and 220° C.

5. The process as claimed in claim 1, characterized in that the solvent comprises butoxyethanol and/or ethanol.

6. The process as claimed in claim 1, characterized in that the first precursor is taken from tetraethyl orthosilicate and trimethoxymethylsilane.

7. The process as claimed in claim 3, characterized in that the surfactant is taken from polyethylene glycols with a molar mass of between 1000 and 2000 g·mol⁻¹, polyethylene glycol tert-octylphenyl ether and polydimethylsiloxane.

8. The process as claimed in claim 1, characterized in that the second precursor is taken from the family of dipodal silanes.

9. The process as claimed in claim 1, characterized in that the second precursor is taken from octadecyltrimethoxysilane, 1,2-bis(triethoxysilyl)ethane, bis(3-(trimethoxysilyl)propyl)amine and the family of the fluoroalkylsilanes.

10. The process as claimed in claim 1, characterized in that the solution comprises, for a total volume of 100 units, a mixture of between 58 and 77 units by volume of solvent, said volume of solvent comprising, for a total volume of solvent of 100 units, between 50 and 95 units by volume of butoxyethanol and between 5 and 50 units by volume of ethanol, between 8 and 28 units by volume of first precursor, between 4 and 11 units by volume of second precursor, between 0.3 and 2 units by volume of acid and between 3 and 17 units by volume of water.

11. The process as claimed in claim 1, characterized in that the solution comprises, for a total volume of 100 units, between 62 and 77 parts of solvent, including, for a total volume of solvent of 100 units or parts, 50 to 95 parts of butoxyethanol and from 5 to 50 parts of ethanol, between 6 and 20 parts of first alkoxysilanes precursor, between 8 and 12 parts of organosilanes precursor, between 1 and 14 parts of silicone oil and between 0.3 and 1 part of acid and between 2 and 4 parts of water.

12. The process as claimed in claim 10, characterized in that a pigment and/or functional additive is added to the solution.

13. The process as claimed in claim 1, characterized in that the solution is formed by:
a first stage of formation of a first mixture of surfactant and of solvent, and the first mixture is placed under stirring for a first predetermined time,
a second stage of formation of a second mixture of solvent and of first and second precursors, and the second mixture is placed under stirring for a second predetermined time,
a third stage of dropwise introduction of the acid into the second mixture in order to form a third mixture, and the third mixture is placed under stirring for a third predetermined time,
the solution is formed by mixing the first mixture and the third with stirring for a fourth predetermined time.

14. A receptacle (15) suitable for containing products biocompatible with man and/or animals, comprising an internal surface (13), characterized in that said internal surface is covered, over at least a part, with a solidified sol-gel coating layer (12) obtained from a solution containing at least one solvent, water, at least one first complexing molecular precursor of the family of the alkoxysilanes, at least one second organofunctional molecular precursor and/or silicone, and citric acid as catalyst, said coating forming a hybrid organo-inorganic matrix arranged in order to produce at least one chemical barrier.

15. The receptacle (15) as claimed in claim 14, characterized in that the coating layer has a thickness of between 60 and 450 min.
